(19) United States
(12) Patent Application Publication
(10) Pub. No.: US 2014/0307429 A1
(43) Pub. Date: Oct. 16, 2014

(54) LIGHT EMITTING DEVICE

(71) Applicant: Shao-Ying Ting, Tainan City (TW)

(72) Inventor: Shao-Ying Ting, Tainan City (TW)

(73) Assignee: Genesis Photonics Inc., Tainan City (TW)

(21) Appl. No.: 14/225,455

(22) Filed: Mar. 26, 2014

(30) Foreign Application Priority Data
Apr. 11, 2013 (TW) 102206609

(51) Int. Cl. F21K 99/00

(52) U.S. Cl. CPC F21K 9/56; F21K 9/52; F21K 9/54
USPC 362/231; 362/235; 362/230

(57) ABSTRACT

A light emitting device includes a base, a light guiding lamp cover, a light-emitting diode (LED) module and a wavelength converting structure. The light guiding lamp cover is disposed on the base and an accommodating space is defined by the light guiding lamp cover and the base together. The light guiding lamp cover has an inner surface, an outer surface and a bottom surface connecting the inner surface and the outer surface. A curvature of the inner surface is greater than a curvature of the outer surface. The LED module is disposed on the base and located inside the accommodating space. The wavelength converting structure is disposed on the LED module and located inside the accommodating space.

### CROSS-REFERENCE TO RELATED APPLICATION

This application claims the priority benefit of Taiwan application serial no. 102206609, filed on Apr. 11, 2013. The entirety of the above-mentioned patent application is hereby incorporated by reference herein and made a part of this specification.

### BACKGROUND OF THE INVENTION

1. Field of the Invention

The invention relates to a light emitting device, and more particularly to a light emitting device using light-emitting diode (LED) chips as a light source.

2. Description of Related Art

Light-emitting diodes (LEDs) have been widely used as indicators or light sources in home appliances and various equipments due to its advantages of long service life, small size, high shock resistance, low heat generation, low power consumption, etc. In recent years, the LEDs are developed to have a high power, and application domains thereof have been extended to road lighting, large outdoor billboards, traffic lights, and related fields. In the future, the LEDs may even become a main illumination light source having both of a power saving function and an environmental protection function.

In conventional LED lamps, the LEDs are usually disposed on a base, and an accommodating space is defined by a lamp cover and the base together and the LEDs are accommodated therein. Since the LEDs generate light with high directivity, when the light generated by the LEDs is transmitted to external surroundings by passing through the lamp cover with same thickness, the non-uniformed light and glare that are easily generated make users feel uncomfortable.

### SUMMARY OF THE INVENTION

The invention provides a light emitting device having a light guiding lamp cover which may enhance light-emitting uniformity and light-emitting angle (i.e. the full-circumferential angle) of the light emitting device.

In the invention, the light emitting device includes a base, a light guiding lamp cover, a light-emitting diode (LED) module and a wavelength converting structure. The light guiding lamp cover is disposed on the base, and an accommodating space is defined by the lamp guiding lamp cover and the base together. The light guiding lamp cover has an inner surface, an outer surface, and a bottom surface connecting the inner surface and the outer surface, wherein a curvature of the inner surface is greater than a curvature of the outer surface. The LED module is disposed on the base and located in the accommodating space. The wavelength converting structure is disposed on the LED module and located inside the accommodating space.

In an embodiment of the invention, the LED module includes a substrate and a plurality of LED chips. The LED chips are disposed on the substrate and electrically connected to the substrate.

In an embodiment of the invention, the wavelength converting structure is disposed with the same shape as the substrate.

In an embodiment of the invention, the substrate has a shape of a circular ring or a polyangular ring.

In an embodiment of the invention, the LED chips are arranged with same intervals.

In an embodiment of the invention, the LED chips are a plurality of LED chips with the same colors.

In an embodiment of the invention, the LED chips are a combination of LED chips with different colors.

In an embodiment of the invention, the wavelength converting structure is in contact with a plurality of light-emitting surfaces of the LED chips.

In an embodiment of the invention, the light emitting device further includes a reflecting structure disposed on the base and surrounding the LED module.

In an embodiment of the invention, the light emitting device further includes a reflecting film disposed on the inner surface of the light guiding lamp cover.

In an embodiment of the invention, the light emitting device further includes a reflecting layer disposed on the inner surface of the light guiding lamp cover. The reflecting layer has a plurality of reflecting particles, and the density of the reflecting particles in the reflecting layer gradually increases from the bottom surface toward a direction away from the bottom surface.

In an embodiment of the invention, the light guiding lamp cover is a parabolic light guiding lamp cover or an elliptic light guiding lamp cover.

Based on the above, since the light emitting device of the invention has a light guiding lamp cover, and the curvature of the inner surface of the light guiding lamp cover is greater than the curvature of the outer surface, the light emitting device of the invention has better light-emitting uniformity, thereby avoiding glare and has a greater light-emitting angle (i.e. the full-circumferential angle).

Several exemplary embodiments accompanied with figures are described in detail below to further describe the invention in details.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the invention.

FIG. 1 is a three-dimensional exploded view illustrating a light emitting device according to an embodiment of the invention.

FIG. 2 is a cross-sectional schematic view illustrating the light emitting device according to FIG. 1.

FIG. 3 is a cross-sectional schematic view illustrating a light emitting device according to another embodiment of the invention.

FIG. 4 is a cross-sectional schematic view illustrating a light emitting device according to another embodiment of the invention.

FIG. 5 is a cross-sectional schematic view illustrating a light emitting device according to another embodiment of the invention.

### DESCRIPTION OF EMBODIMENTS

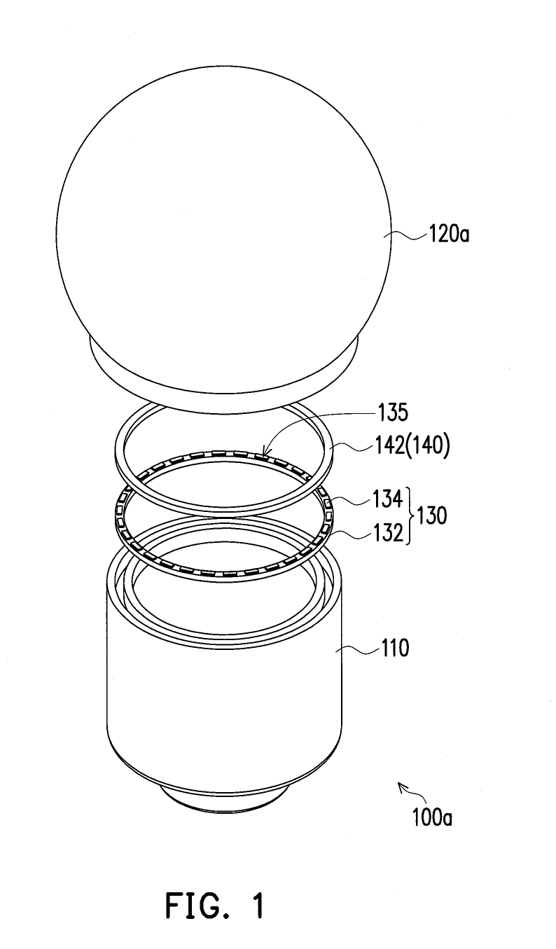

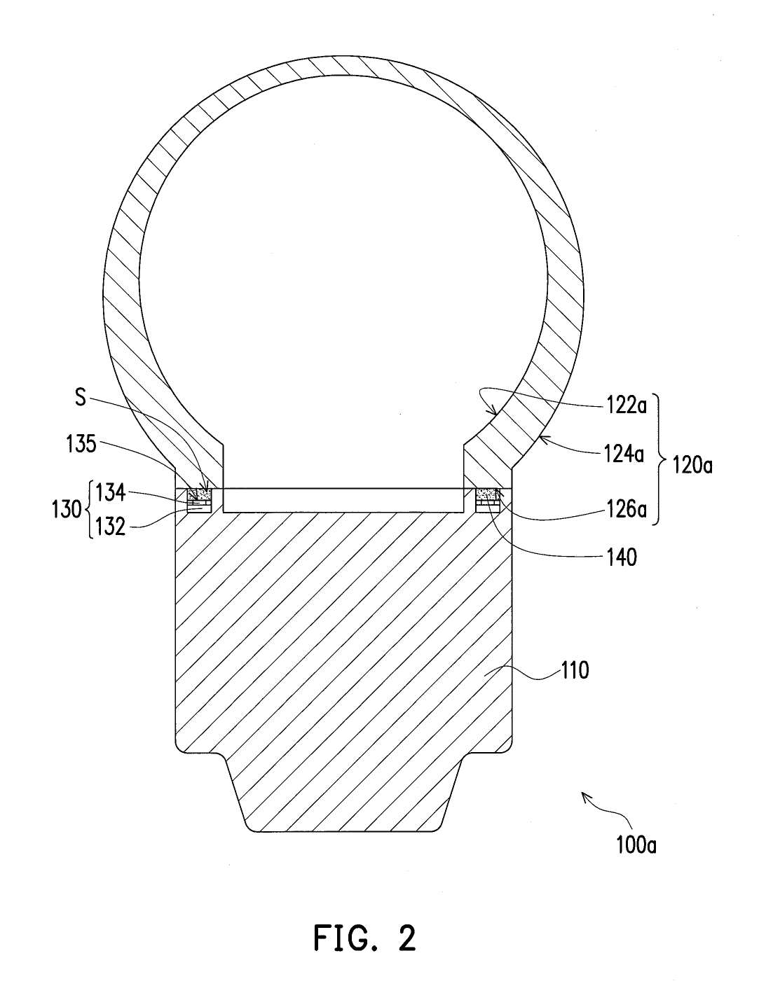

FIG. 1 is a three-dimensional exploded view illustrating a light emitting device according to an embodiment of the invention. FIG. 2 is a cross-sectional schematic view illustrating the light emitting device according to FIG. 1. Please refer to both FIGS. 1 and 2. In the embodiment, a light emitting device 100a includes a base 110, a light guiding lamp cover 120a, a light-emitting diode (LED) module 130, and a wavelength converting structure 140. The light guiding lamp cover 120a is disposed on the base 110, and an accommodating space S is defined by the light guiding lamp cover 120a and the base 110 together. The light guiding lamp cover 120a has an inner surface 122a, an outer surface 124a, and a bottom surface 126a connecting the inner surface 122a and the outer surface 124a. Specifically, a curvature of the inner surface 122a is greater than a curvature of the outer surface 124a. The LED module 130 is disposed on the base 110 and located inside the accommodating space S. The wavelength converting structure 140 is disposed on the LED module 130 and located inside the accommodating space S.

More specifically, please refer to FIG. 1 again. The light guiding lamp cover 120a in the embodiment is, for example, a parabolic light guiding lamp cover, wherein the curvature of the inner surface 122a is greater than the curvature of the outer surface 124a. That is to say, the light guiding lamp cover 120a has a non-uniform thickness. Here, the bottom surface 126a connects the inner surface 122a with the outer surface 124a, wherein the bottom surface 126a is formed of straight lines and the curvature thereof is 0. As shown in FIG. 2, the thickness of the light guiding lamp cover 120a gradually decreases from a portion adjacent LED module 130 toward another portion away from the LED module 130. Such design allows the light emitted by the LED module 130 to be uniformly emitted from the light guiding lamp cover 120a when being transmitted in the light guiding lamp cover 120a so the light is not concentrated too much on a portion of the light guiding lamp cover 120a, such as in a front view direction. In other words, the light guiding lamp cover 120a has a better light guiding effect relative to conventional lamp covers with same thickness. Certainly, the invention provides no limitation to the shape of the light guiding lamp cover 120a. Although the light guiding lamp cover 120a referred here is specifically described as a parabolic light guiding lamp cover, in other embodiments that are not shown, the light guiding lamp cover 120a may also be an elliptic light guiding lamp cover, which still belongs to a technical solution adoptable by the invention without departing from the scope sought to be protected by the invention.

Please further refer to FIG. 1. The LED module 130 includes a substrate 132 and a plurality of LED chips 134, wherein the LED chips 134 are disposed on the substrate 132 and arranged with same intervals. The LED chips 134 are electrically connected to the substrate 132, and the LED chips 134 are electrically connected to an actuator (not shown) in the base 110 via the substrate 132. Here, the LED chips 134 may be LED chips with the same color or a combination of LED chips with different colors, which should not be construed as a limitation to the invention. As shown in FIGS. 1 and 2, in the embodiment, the substrate 132 of the LED module 130 may be disposed with the same shape as the wavelength converting structure 140. That is, the shape of the substrate 132 of the LED module 130 is the same as the shape of the wavelength converting structure 140, such as the shape of a circular ring. Certainly, in other embodiments that are not shown, the shapes of the substrate 132 of the LED module 130 and the wavelength converting structure 140 may also be the shapes of a rectangular ring, other suitable polyangular rings, or an irregular ring, which should not be construed as a limitation to the invention.

In addition, as shown in FIG. 2, in the embodiment, since the wavelength converting structure 140 is directly in contact with a plurality of light-emitting surfaces 135 of the LED chips 134, the light emitted by the LED chips 134 may be converted into light of different colors directly through the wavelength converting structure 140, such as white light, and transmitted through the light guiding effect of the light guiding lamp cover 120a so that the light emitting device 100a achieves the uniform light-emitting effect. Here, the wavelength converting structure 140 is, for example, formed of at least a fluorescent layer 142, wherein the fluorescent layer 142 is, for example, a yellow fluorescent layer, a blue fluorescent layer, a red fluorescent layer, or a green fluorescent layer, which should not be construed as a limitation to the invention.

In the embodiment, since the light emitting device 100a has the light guiding lamp cover 120a, and the curvature of the inner surface 122a of the light guiding lamp cover 120a is greater than the curvature of the outer surface 124a, the light emitted by the LED chips 134 of the LED module 130 may not be easily concentrated in the front view direction with the design of the light guiding lamp cover 120a; that is, the light can be uniformized. Therefore, the light emitting device 100a of the embodiment may have better light-emitting uniformity, thereby avoiding the glare. Furthermore, with the light guiding effect of the light guiding lamp cover 120a, the light emitted by the LED module 130 may allow the entire light emitting device 100a to have a larger light-emitting angle (i.e. the full-circumferential angle) relative to the conventional light emitting device.

It should be mentioned that the present embodiment has adopted component notations and part of the contents from the previous embodiment, wherein the same notations are used for representing the same or similar components, and descriptions of the same technical contents are omitted. The descriptions regarding the omitted part may be referred to the previous embodiment, and thus is not repeated herein.

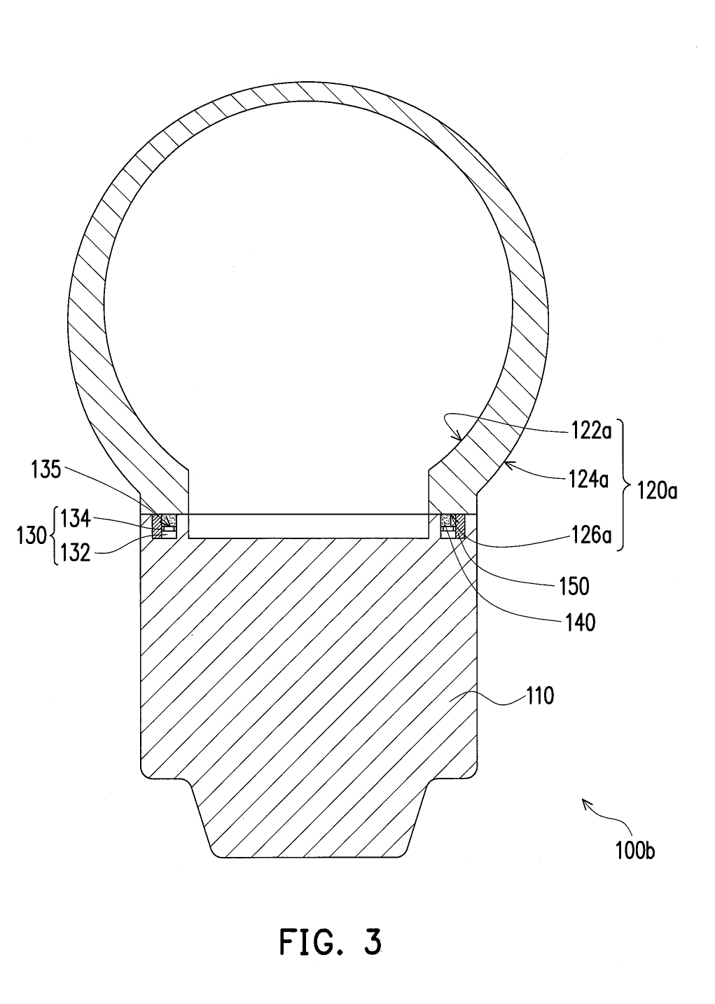

FIG. 3 is a cross-sectional schematic view illustrating a light emitting device according to another embodiment of the invention. Please refer to FIG. 3. In the embodiment, a light emitting device 100b is similar to the light emitting device 100a of FIG. 2, and the only difference lies in that the light emitting device 100b in the embodiment may further include a reflecting structure 150, wherein the reflecting structure 150 is disposed on the base 110 and surrounds the LED module 130. In the embodiment, since the light emitting device 100b has a reflecting structure 150, a lateral light emitted by the LED chips 134 of the LED. module 130 may be reflected on the light-emitting surface 135 of the LED chips 134 via the reflecting structure 150 and then converted to have different colors via the wavelength converting structure 140, such as white light, thereby acquiring better light-emitting uniformity via the light guiding lamp cover 120a. Accordingly, the light emitting device 100b of the embodiment may enhance the entire light-emitting uniformity and light-emitting efficiency through the reflecting efficiency of the reflecting structure 150 and the light guiding effect of the light guiding lamp cover 120a.

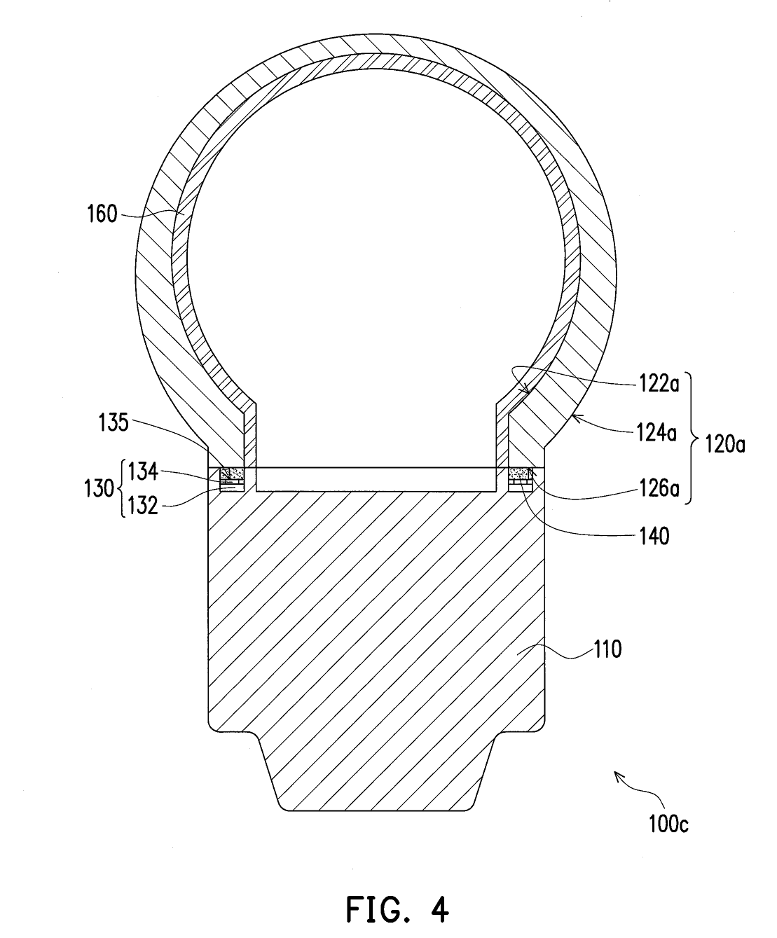

FIG. 4 is a cross-sectional schematic view illustrating a light emitting device according to another embodiment of the invention. Please refer to FIG. 4. A light emitting device 100c of the embodiment is similar to the light emitting device 100a of FIG. 2, and the only difference lies in that the light emitting device 100c of the embodiment may further include a reflecting film 160, wherein the reflecting film 160 is disposed on the inner surface 122a of the light guiding lamp cover 120a. Here, as shown in FIG. 4, the reflecting film 160 is a film layer having uniform thickness, and the reflecting film 160 is disposed with the same shape as the inner surface 122a of the light guiding lamp cover 120a. That is, the curvature of the reflecting film 160 is substantially the same as the curvature of the inner surface 122a. Since the light emitting device 100c of the embodiment has the reflecting film 160, after entering the light guiding lamp cover 120a, the light emitted by the LED chips 134 of the LED module 130 may reflect the light that is toward the inner surface 122a of the light guiding lamp cover 120a outward via the reflection of the reflecting film 160, thereby increasing the light guiding effect and uniformity of the light guiding lamp cover 120a so that the light-emitting uniformity and light-emitting efficiency of the entire light emitting device 100c may be increased.

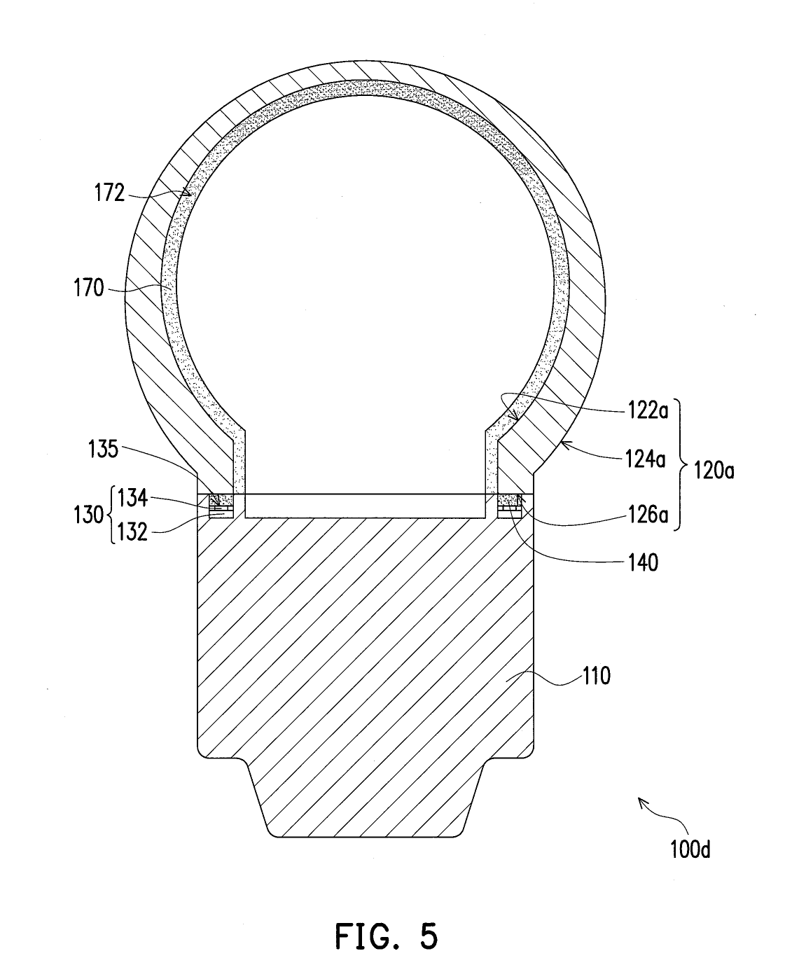

FIG. 5 is a cross-sectional schematic view illustrating a light emitting device according to another embodiment of the invention. Please refer to FIG. 5. In the embodiment, a light emitting device 100d is similar to the light emitting device 100a of FIG. 2, and the only difference lies in that the light emitting device 100d of the embodiment may further include a reflecting layer 170, wherein the reflecting layer 170 is disposed on the inner surface 122a of the light guiding lamp cover 120a. Specifically, the reflecting layer 170 of the embodiment has a plurality of reflecting particles 172, and the density of the reflecting particles 172 within the reflecting layer 170 gradually increases from the bottom surface 126a toward a direction away from the bottom surface 126a. Since the light emitting device 100d of the embodiment has the reflecting layer 170, after entering the light guiding lamp cover 120a, the light emitted by the LED chips 134 of the LED module 130 may increase the light guiding effect and uniformity of the light guiding lamp cover 120a via the reflecting efficiency of the reflecting particles 172, thereby increasing the light-emitting uniformity and light-emitting efficiency of the entire light emitting device 100d.

In addition, in other embodiments that are not shown, the reflecting structure 150, reflecting film 160, or reflecting layer 170 mentioned in the above embodiments may be adopted; persons skilled in the art may select the above elements to achieve the desired technical effect based on actual needs by referring to the descriptions in the above embodiments.

To sum up, since the light emitting device of the invention has a light guiding lamp cover, and the curvature of the inner surface of the light guiding lamp cover is greater than the curvature of the outer surface, the light emitting device of the invention has better light-emitting uniformity, thereby avoiding glare and has a larger light-emitting angle (i.e. the full-circumferential angle).

It will be apparent to those skilled in the art that various modifications and variations can be made to the structure of the disclosed embodiments without departing from the scope or spirit of the invention. In view of the foregoing, it is intended that the disclosure cover modifications and variations of this specification provided they fall within the scope of the following claims and their equivalents.

What is claimed is:

1. A light emitting device, comprising:
a base;
a light guiding lamp cover, disposed on the base and an accommodating space being defined by the light guiding lamp cover and the base together, the light guiding lamp cover having an inner surface, an outer surface, and a bottom surface connecting the inner surface and the outer surface, wherein a curvature of the inner surface is greater than a curvature of the outer surface;
a light-emitting diode (LED) module, disposed on the base and located inside the accommodating space; and
a wavelength converting structure, disposed on the LED module and located inside the accommodating space.

2. The light emitting device as recited in claim 1, wherein the LED module comprises:
a substrate; and
a plurality of light-emitting diode (LED) chips disposed on the substrate and electrically connected to the substrate.

3. The light emitting device as recited in claim 2, wherein the wavelength converting structure is disposed with the same shape as the substrate.

4. The light emitting device as recited in claim 2, wherein the substrate has a shape of a circular ring or a polyangular ring.

5. The light emitting device as recited in claim 2, wherein the LED chips are arranged with same intervals.

6. The light emitting device as recited in claim 2, wherein the LED chips are a plurality of LED chips with the same color.

7. The light emitting device as recited in claim 2, wherein the LED chips are a combination of a plurality of LED chips with different colors.

8. The light emitting device as recited in claim 2, wherein the wavelength converting structure is in contact with a plurality of light-emitting surfaces of the LED chips.

9. The light emitting device as recited in claim 1, further comprising a reflecting structure disposed on the base and surrounding the LED module.

10. The light emitting device as recited in claim 1, further comprising a reflecting film disposed on the inner surface of the light guiding lamp cover.

11. The light emitting device as recited in claim 1, further comprising a reflecting layer disposed on the inner surface of the light guiding lamp cover, wherein the reflecting layer has a plurality of reflecting particles, and a density of the reflecting particles within the reflecting layer gradually increases from the bottom surface toward a direction away from the bottom surface.

12. The light emitting device as recited in claim 1, wherein the light guiding lamp cover is a paraboloid light guiding lamp cover or an ellipsoid light guiding lamp cover.
